(19) United States
(12) Patent Application Publication
(10) Pub. No.: US 2023/0136269 A1
(43) Pub. Date: May 4, 2023

(54) SYSTEMS AND METHODS FOR DYNAMIC SKETCHING WITH EXAGGERATED CONTENT

(71) Applicant: Wacom Co., Ltd., Saitama (JP)

(72) Inventors: Oluwaseyi Sosanya, London (GB); Daniela Paredes-Fuentes, London (GB); Daniel Thomas, London (GB)

(21) Appl. No.: 18/148,343

(22) Filed: Dec. 29, 2022

Related U.S. Application Data
(63) Continuation of application No. PCT/IB2021/055650, filed on Jun. 25, 2021.

(51) Int. Cl. G06F 3/0346; G06T 19/20; G06F 3/0354; G06F 3/01; G06F 3/03

(52) U.S. Cl. CPC G06F 3/0346; G06T 19/20; G06F 3/03545; G06F 3/017; G06F 3/0325; G06T 2219/2016

(57) ABSTRACT

A system receives signals indicating positions of a position indicator and indicating of a surface of a physical object. The system obtains a description of a portion of the surface of the physical object based on the signals indicating the positions of the position indicator and the surface of the physical object. The system also determines whether the position indicator is on or over the portion of the surface of the physical object based on the signals indicating the positions of the position indicator. Responsive to determining that the position indicator is on or over the portion of the surface of the physical object, the system obtains and stores coordinates corresponding to an input gesture based on the signals indicating the positions of the position indicator. Accordingly, the position indicator can be used as an input device while disposed on or over an arbitrary physical surface.

### BACKGROUND

### Technical Field

The present disclosure relates to specifying dimensions of multidimensional objects represented in digital data, and more particularly to systems and methods for dynamically sketching shapes of such multidimensional objects using an input surface.

### Description of the Related Art

Software applications have enabled users of a tablet computer, for example, to sketch or otherwise specify dimensions of multidimensional objects represented in digital data by performing input operations on a touchscreen device of the tablet computer. It may be difficult, however, to sketch objects that are larger than the input surface of the touchscreen device. Accordingly, it is desirable to provide systems and methods that exaggerate or enhance input gestures in order to enable users to specify shapes, orientations, dimensions, etc. of relatively large objects represented in digital data. In addition, it is desirable to provide systems and methods that enable an arbitrary physical surface having an arbitrary size to be used as an input surface for specifying shapes, orientations, dimensions, etc. of multidimensional objects represented in digital data.

### BRIEF SUMMARY

The present disclosure teaches systems and methods that enable users to specify shapes, orientations, dimensions, etc. of multidimensional objects represented in digital data using an arbitrary physical surface having an arbitrary size. In addition, the present disclosure teaches systems and methods that enable users to specify shapes, orientations, dimensions, etc. of relatively large multidimensional objects represented in digital data using exaggerated user input gestures.

A method according to a first embodiment of the present disclosure may be summarized as including: receiving one or more signals indicative of a plurality of spatial positions of a position indicator in a 3-dimensional space; receiving one or more signals indicative of a surface of a physical object in the 3-dimensional space; obtaining a description of a portion of the surface of the physical object based on the one or more signals indicative of the plurality of spatial positions of the position indicator and the one or more signals indicative of the surface of the physical object; determining whether the position indicator is on or over the portion of the surface of the physical object based on the one or more signals indicative of the plurality of spatial positions of the position indicator; responsive to determining that the position indicator is on or over the portion of the surface of the physical object, obtaining coordinates corresponding to an input gesture based on the one or more signals indicative of the plurality of spatial positions of the position indicator; and storing the coordinates corresponding to the input gesture.

The method may further include: displaying a virtual representation of the position indicator along with a virtual representation of the portion of the surface of the physical object.

The method may further include: receiving one or more signals indicative of a plurality of positions of a switch of the position indicator; and determining whether the switch of the position indicator is in a first positon, based on the one or more signals indicative of the plurality of positions of the switch of the position indicator, wherein the obtaining of the coordinates corresponding to the input gesture may be responsive to determining that the position indicator is on or over the portion of the surface of the physical object and responsive to determining that the switch of the position indicator is in the first positon.

The method may further include: translating coordinates corresponding to the portion of the surface of the physical object from a first coordinate system to a second coordinate system, the first coordinate system being different from the second coordinate system.

The position indicator may include a plurality of reference tags, and the one or more signals indicative of the plurality of spatial positions of the position indicator are indicative of a plurality of positions of the reference tags. Each of the reference tags may include a visually distinct pattern formed thereon, and the one or more signals indicative of the plurality of spatial positions of the position indicator may include image data corresponding to a plurality of images of the references tags. Each of the reference tags may emit light, and the one or more signals indicative of the plurality of spatial positions of the position indicator may include image data corresponding to a plurality of images of the references tags.

A method according to a first embodiment of the present disclosure may be summarized as including: receiving one or more signals indicative of a plurality of spatial positions of a position indicator in a 3-dimensional space; obtaining one or more signals indicative of a scaling factor; obtaining coordinates corresponding to an input gesture in the 3-dimensional space based on the one or more signals indicative of the plurality of spatial positions of the position indicator; scaling the coordinates corresponding to the input gesture based on the one or more signals indicative of the scaling factor; and displaying a virtual representation of the input gesture based on the scaling of the coordinates corresponding to the input gesture.

The method may further include: displaying the scaling factor.

The method may further include: receiving a signal indicative of a pressure applied to a part of the position indicator, wherein the scaling factor is based on the signal indicative of the pressure applied to the part of the position indicator.

The method may further include: receiving a signal indicative of an acceleration of the position indicator, wherein the scaling factor is based on the signal indicative of the acceleration of the position indicator.

The method may further include: receiving one or more signals indicative of a plurality of positions of a switch of the position indicator; and determining whether the switch of the position indicator is in a first positon, based on the one or more signals indicative of the plurality of positions of the switch of the position indicator, wherein the obtaining of the coordinates corresponding to the input gesture is responsive to determining that the switch of the position indicator is in the first positon.

The method may further include: determining whether the switch of the position indicator is in a second positon, based on the one or more signals indicative of the plurality of positions of the switch of the position indicator, wherein the obtaining of the coordinates corresponding to the input gesture is ended responsive to determining that the switch of the position indicator is in the second positon.

The position indicator may include a plurality of reference tags, and the one or more signals indicative of the plurality of spatial positions of the position indicator are indicative of a plurality of positions of the reference tags. Each of the reference tags may include a visually distinct pattern formed thereon, and the one or more signals indicative of the plurality of spatial positions of the position indicator include image data may correspond to a plurality of images of the references tags. Each of the reference tags may emit light, and the one or more signals indicative of the plurality of spatial positions of the position indicator include image data may correspond to a plurality of images of the references tags.

A system according to a third embodiment of the present disclosure may be summarized as including: one or more receivers which, in operation, receive one or more signals indicative of a plurality of spatial positions of a position indicator in a 3-dimensional space, and one or more signals indicative of a surface of a physical object in the 3-dimensional space; one or more processors coupled to the one or more receivers; and one or more memory devices coupled to the one or more processors, the one or more memory devices storing instructions that, when executed by the one or more processors, cause the system to: obtain a description of a portion of the surface of the physical object based on the one or more signals indicative of the plurality of spatial positions of the position indicator and the one or more signals indicative of the surface of the physical object; determine whether the position indicator is on or over the portion of the surface of the physical object based on the one or more signals indicative of the plurality of spatial positions of the position indicator; responsive to determining that the position indicator is on or over the portion of the surface of the physical object, obtain coordinates corresponding to an input gesture based on the one or more signals indicative of the plurality of spatial positions of the position indicator; and store the coordinates corresponding to the input gesture.

The one or more memory devices may store instructions that, when executed by the one or more processors, cause the system to display a virtual representation of the position indicator along with a virtual representation of the portion of the surface of the physical object.

The one or more memory devices may store instructions that, when executed by the one or more processors, cause the system to: obtain an indication of a scaling factor; and obtain coordinates corresponding to a scaled input gesture based on the scaling factor and the coordinates corresponding to the input gesture. The one or more memory devices may store instructions that, when executed by the one or more processors, cause system to display a virtual representation of the scaled input gesture.

### BRIEF DESCRIPTION OF THE SEVERAL VIEWS OF THE DRAWINGS

FIG. 1 shows a block diagram of a visualization system, according to one or more embodiments of the present disclosure;

FIG. 2 shows a block diagram of a position indicator that is used as an input device, according to one or more embodiments of the present disclosure;

FIG. 3 shows a block diagram of a processing device that receives input via the position indicator shown in FIG. 2, according to one or more embodiments of the present disclosure;

FIG. 4 shows a flowchart of a method that may be performed by the visualization system shown in FIG. 1, according to one or more embodiments of the present disclosure;

FIGS. 5A and 5B show a flowchart of a method that may be performed by the visualization system shown in FIG. 1, according to one or more embodiments of the present disclosure;

FIGS. 6A, 6B, 6C, and 6D are diagrams for explaining operation of the visualization system shown in FIG. 1, according to one or more embodiments of the present disclosure;

FIG. 7 shows a flowchart of a method that may be performed by the visualization system shown in FIG. 1, according to one or more embodiments of the present disclosure; and

FIGS. 8A and 8B are diagrams for explaining operation of the visualization system shown in FIG. 1, according to one or more embodiments of the present disclosure.

### DETAILED DESCRIPTION

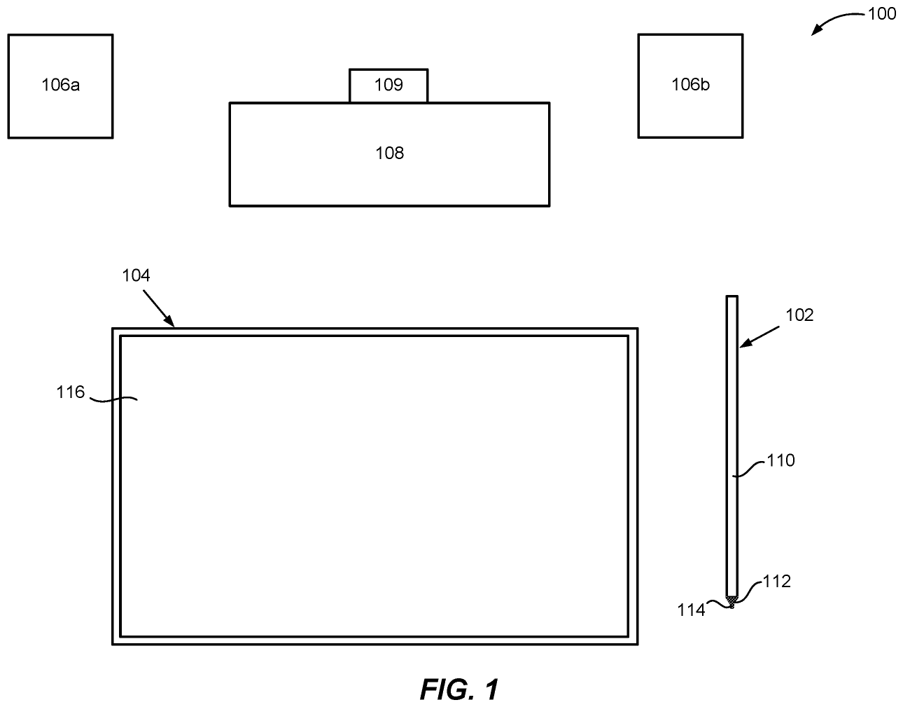

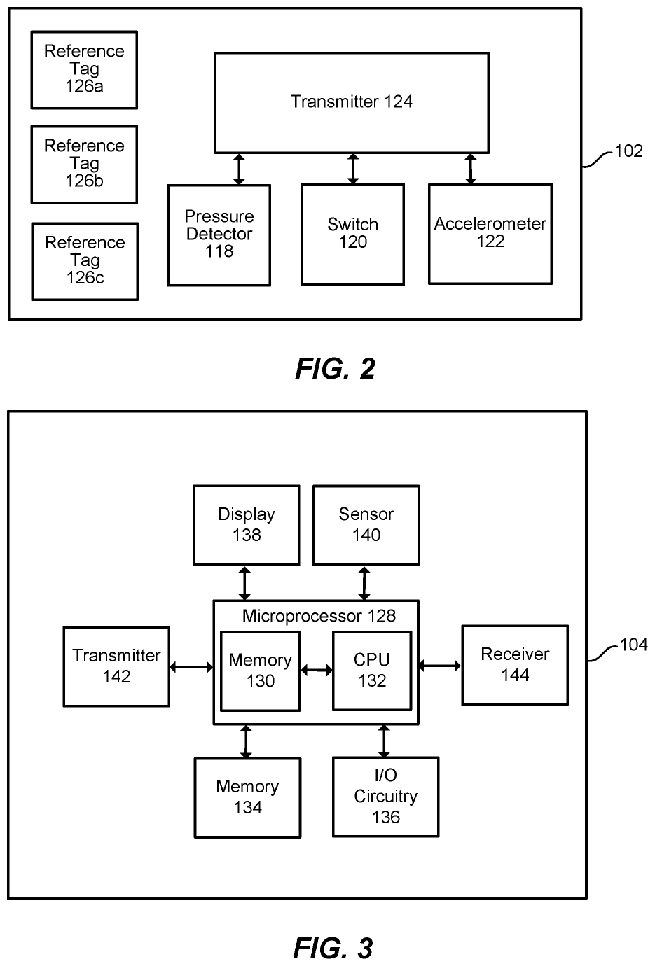

FIG. 1 shows a block diagram of a visualization system 100, according to one or more embodiments of the present disclosure. The visualization system 100 includes a position indicator 102, a processing device 104, a plurality of tracking devices 106a and 106b, a visualization device 108, and a sensor 109. In the illustrated embodiment, the position indicator 102 includes a hollow case 110 having an opening 112 formed at one end thereof, though the case of the position indicator 102 may have other, different forms. In one or more embodiments, the case 110 has a generally cylindrical shape. The case 110 may have other shapes without departing from the scope of the present disclosure. A tip of a core body 114 protrudes from the case 110 through the opening 112. In one or more embodiments, the core body 114 is a rod-shaped member that transmits pressure corresponding to a pressure applied to a part of the position indicator (e.g., tip of a core body 114), to a pressure detector 118, which will be described below with reference to FIG. 2. In one or more embodiments, the core body 114 is formed of an electrically-conductive material. In one or more embodiments, the core body 114 is non-conductive and is formed from resin.

Alternatively or in combination, in one or more embodiments, the opening 112 is formed in a side surface of the case 110, and the core body 114 extends through the opening 112 thereby enabling a finger of a user to apply pressure to the core body in order to provide input to the processing device 104. As will be explained below with reference to FIG. 2, the position indicator 102 transmits to the processing device 104 a signal that is indicative of an amount of pressure applied to the tip of the core body 114. The position indicator 102 can be used as an input device for the processing device 104.

The processing device 104 includes an input surface 116, for example, which is formed from a transparent material such as glass. In one or more embodiments, the processing device 104 is a tablet computer. As will be explained below with reference to FIG. 3, a sensor 140 that tracks the current position of the position indicator 102 and a display device 138 may be disposed below the input surface 116. The processing device 104 generates visualization data based on operation of the position indicator 102 by a user, and transmits the visualization data to the visualization device 108, which displays images based on the visualization data. Additionally or alternatively, the display device 138 of the processing device 104 may display images based on the visualization data.

In one or more embodiments, the visualization device 108 and the display device 138 each process portions of the visualization data generated by the processing device 104 and simultaneously display images. In one or more embodiments, the visualization device 108 and the display device 138 operate with different screen refresh rates. Accordingly, it may be desirable offload processing of the device operating at the higher screen refresh rate to the device operating at the lower screen refresh rate. For example, the visualization device 108 may operate with a screen refresh rate of 90 Hz and the display device 138 may operate with a screen refresh rate of 60 Hz, and in such case it may be desirable to offload some or all of the processing of visualization data by the visualization device 108 to the display device 138. Thus, the processing device 104 may partition the visualization data such that a processing load of the visualization device 108 is offloaded to the display device 138.

In one or more embodiments, the processing device 104 receives from the visualization device 108 a signal indicative of a current processing load of the visualization device 108, and the processing device 104 dynamically adjusts the amount of visualization data transmitted to the visualization device 108 and the display device 138 based on the current processing load. In one or more embodiments, the processing device 104 estimates the current processing load of the visualization device 108, and dynamically adjusts the amount of visualization data transmitted to the visualization device 108 and the display device 138 based on the estimated current processing load. For example, if the indicated or estimated current processing load of the visualization device 108 is greater than or equal to a predetermined threshold value, the processing device 104 decreases the amount of visualization data that is transmitted to the visualization device 108 and increases the amount of visualization data that is transmitted to the display device 138. Additionally or alternatively, the processing device 104 may offload processing from the display device 138 to the visualization device 108 in a similar manner.

The tracking devices 106a and 106b track the position and/or orientation of the position indicator 102, and particularly, in some embodiments, the tip of the core body 114 of the position indicator 102. The tracking devices 106a and 106b are collectively referred to herein as tracking devices 106. Although the embodiment shown in FIG. 1 includes two tracking devices 106, the visualization system 100 may include a different number of tracking devices 106 without departing from the scope of the present disclosure. For example, the visualization system 100 may include three, four, or more tracking devices 106 according to the present disclosure. In one or more embodiments, the visualization system 100 does not include any tracking devices 106, and the position of the tip of the core body 114 of the position indicator 102 is tracked using only the sensor 140 of the processing device 104.

In one or more embodiments, the tracking devices 106 employ known optical motion tracking technologies in order to track the position and/or orientation of the tip of the core body 114 of the position indicator 102. In one or more embodiments, the position indicator 102 has reference tags in the form of optical markers mounted on an exterior surface of the case 110, wherein the optical markers are passive devices each having a unique, visually distinct color or pattern formed thereon that can be optically sensed. Each of the tracking devices 106 may include a camera that obtains images of one or more of the optical markers and transmits corresponding image data to the processing device 104. The processing device 104 stores data indicative of a spatial relationship between each of the optical markers and the tip of the core body 114 of the position indicator 102, and determines a current position and/or orientation of the tip of the core body 114 of the position indicator 102 by processing the image data according to known techniques. In one or more embodiments, the optical markers are active devices each having a light emitting device (e.g., light emitting diode) that emits light having a different wavelength. For example, the light emitted by such optical markers may be ultraviolet light that is not visible to the human eye. In one or more embodiments, the tracking devices 106 are Constellation sensors, which are part of the Oculus Rift system available from Oculus VR. In one or more embodiments, the tracking devices 106 are laser-based tracking devices. For example, the tracking devices 106 are SteamVR 2.0 Base Stations, which are part of the HTC Vive system available from HTC Corporation.

The visualization device 108 processes the visualization data that is generated by the processing device 104, and displays corresponding images. In one or more embodiments, the visualization device 108 is a head-mounted display device. In one or more embodiments, the visualization device 108 is an HTC Vive Pro virtual reality headset, which is part of the HTC Vive system available from HTC Corporation. In one or more embodiments, the visualization device 108 is an Oculus Rift virtual reality headset, which is part of the Oculus Rift system available from Oculus VR. In one or more embodiments, the visualization device 108 is a HoloLens augmented reality headset available from Microsoft Corporation. Other types of headsets may be used, for example, Magic Leap headsets and Meta headsets, among others.

In one or more embodiments, the visualization device 108 includes the sensor 109, which is used to track the location of physical objects within a field of view of the sensor 109. For example, the visualization device 108 is a head-mounted display and the sensor 109 includes a pair of cameras, wherein each camera is located near one eye of a user of the visualization device 108 and has a field of view that is substantially the same as that eye. Additionally, the visualization device 108 includes a transmitter that transmits image data corresponding to the images captured by the cameras to the processing device 104, which processes the image data and determines coordinates for objects imaged by the cameras, for example, using conventional image processing techniques. For example, in one or more embodiments, the processing device 104 includes object recognition software that is configured in a manner similar to the object recognition engine described in U.S. Patent Application Publication No. 2012/0206452, see e.g., paragraph 87, which is incorporated by reference herein in its entirety. Alternatively, the visualization device 108 includes a processor and a memory storing instructions that, when executed by the processor, cause the visualization device 108 to determine coordinates for objects imaged by the cameras and transmit those coordinates to the processing device 104.

Having provided an overview of the visualization system 100, the position indicator 102 will now be described in greater detail with reference to FIG. 2, which shows a block diagram of the position indicator 102, according to one or more embodiments of the present disclosure. The position indicator 102 includes a pressure detector 118 which, in operation, detects a pressure applied to the tip of the core body 114, for example, when a user presses the tip of the core body 114 against the input surface 116 of the processing device 104. In one or more embodiments, the pressure detector 118 is configured in a manner similar to the pressure sensing component described in U.S. Pat. No. 9,939,931, see e.g., column 13, line 49, to column 22, line 13, which is incorporated by reference herein in its entirety.

In one or more embodiments, the position indicator 102 includes a switch 120 which in operation, is in one of a plurality of positions. A user can actuate the switch 120 to change the position of the switch 120 in order to provide input to the processing device 104. For example, the switch 120 is in a “closed” or “on” position while a user depresses it, and is in an “open” or “off” position while the user does not depress it. In one or more embodiments, the switch 120 is configured in a manner similar to the side switch described in U.S. Pat. No. 9,939,931, see e.g., column 11, lines 24-49. In one or more embodiments, the position indicator 102 includes two switches 120 that a user can operate to provide input similar to the input provided by operating a left button and a right button of a computer mouse.

In one or more embodiments, the position indicator 102 includes an accelerometer 122 which, in operation, outputs a signal indicative of an acceleration of the position indicator 102. In one or more embodiments, the accelerometer 122 is configured as a micro-machined microelectromechanical system (MEMS).

The position indicator 102 also includes a transmitter 124 coupled to the pressure detector 118, and the transmitter 124, in operation, transmits a signal indicative of the pressure applied to the tip of the core body 114 that is detected by the pressure detector 118. In one or more embodiments, the transmitter 124 operates in accordance with one or more of the Bluetooth communication standards. In one or more embodiments, the transmitter 124 operates in accordance with one or more of the IEEE 802.11 family of communication standards. In one or more embodiments, the transmitter 124 electromagnetically induces the signal via the tip of the core body 114 and the sensor 140 of the processing device 104. In one or more embodiments, the transmitter 124 is coupled to the switch 120, and the transmitter 124, in operation, transmits a signal indicative of the position of the switch 120. In one or more embodiments, the transmitter 124 is coupled to the accelerometer 122, and the transmitter 124, in operation, transmits a signal indicative of the acceleration of the position detection device 102 that is detected by the accelerometer 122.

In one or more embodiments, the position indicator 102 includes a plurality of reference tags 126a, 126b, and 126c. The reference tags 126a, 126b, and 126c are collectively referred to herein as reference tags 126. The reference tags 126 are tracked by the tracking devices 106. In one or more embodiments, the reference tags 126 are passive optical markers that are secured to an exterior surface of the case 110 of the position indicator 102, as described above in connection with FIG. 1. Alternatively or in addition, in one or more embodiments, the reference tags 126 actively emit light or radio waves that are detected by the tracking devices 106. Although the embodiment shown in FIG. 2 includes three reference tags 126, the position indicator 102 may include a different number of reference tags 126. For example, the position indicator 102 may include four, five, six, or more reference tags 126 according to the present disclosure.

Having described the position indicator 102 in greater detail, the processing device 104 will now be described in greater detail with reference to FIG. 3, which shows a block diagram of the processing device 104, according to one or more embodiments of the present disclosure. The processing device 104 includes a microprocessor 128 having a memory 130 and a central processing unit (CPU) 132, a memory 134, input/output (I/O) circuitry 136, a display device 138, a sensor 140, a transmitter 142, and a receiver 144.

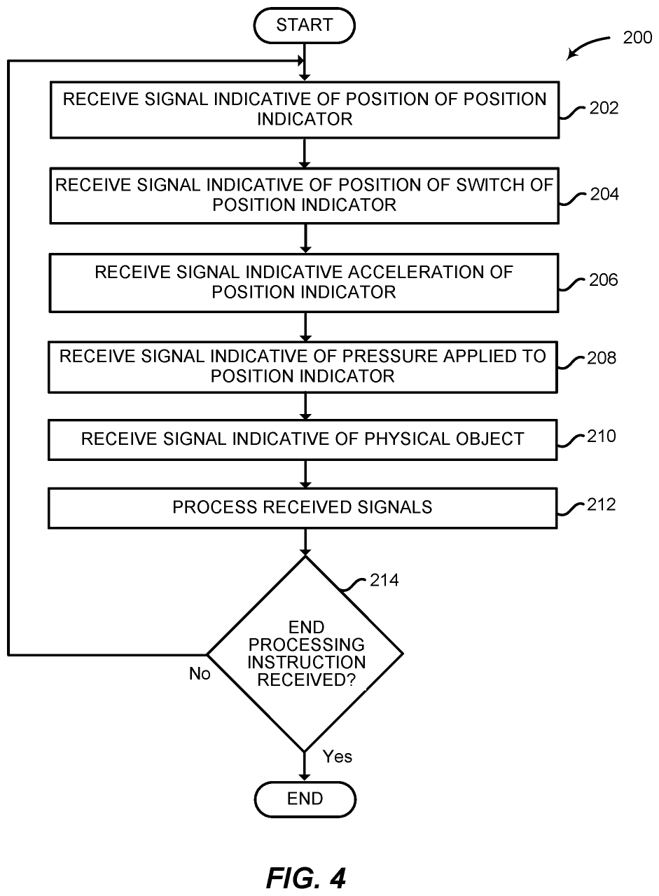

The memory 134 stores processor-executable instructions that, when executed by the CPU 132, cause the processing device 104 to perform the acts of the processing device 104 described in connection with FIGS. 4, 5A, 5B, and 7. The CPU 132 uses the memory 130 as a working memory while executing the instructions. In one or more embodiments, the memory 130 is comprised of one or more random access memory (RAM) modules and/or one or more non-volatile random access memory (NVRAM) modules, such as electronically erasable programmable read-only memory (EEPROM) or Flash memory modules, for example.

In one or more embodiments, the I/O circuitry 136 may include buttons, switches, dials, knobs, microphones, or other user-interface elements for inputting commands to the processing device 104. The I/O circuitry 136 also may include one or more speakers, one or more light emitting devices, or other user-interface elements for outputting information or indications from the processing device 104.

The display device 138 graphically displays information to an operator. The microprocessor 128 controls the display device 138 to display information based on visualization data generated by the processing device 104. In one or more embodiments, the display device 138 is a liquid crystal display (LCD) device. In one or more embodiments, the display device 138 simultaneously displays two images so that users wearing appropriate eyewear can perceive a multidimensional image, for example, in a manner similar to viewing three-dimensional (3D) images via 3D capable televisions.

The sensor 140 detects the position indicator 102 and outputs a signal indicative of a position of the position indicator 102 with respect to an input surface (e.g., surface 116) of the sensor 140. In one or more embodiments, the microprocessor 128 processes signals received from the sensor 140 and obtains (X, Y) coordinates on the input surface of the sensor 140 corresponding to the position indicated by the position indicator 102. In one or more embodiments, the microprocessor 128 processes signals received from the sensor 140 and obtains (X, Y) coordinates on the input surface of the sensor 140 corresponding to the position indicated by the position indicator 102 in addition to a height (e.g., Z coordinate) above the input surface of the sensor 140 at which the position indicator 102 is located. In one or more embodiments, the sensor 140 is an induction type of sensor that is configured in a manner similar to the position detection sensor described in U.S. Pat. No. 9,964,395, see e.g., column 7, line 35, to column 10, line 27, which is incorporated by reference herein in its entirety. In one or more embodiments, the sensor 140 is a capacitive type of sensor that is configured in a manner similar to the position detecting sensor described in U.S. Pat. No. 9,600,096, see e.g., column 6, line 5, to column 8, line 17, which is incorporated by reference herein in its entirety.

The transmitter 142 is coupled to the microprocessor 128, and the transmitter 142, in operation, transmits visualization data generated by the microprocessor 128 to the visualization device 108. For example, in one or more embodiments, the transmitter 142 operates in accordance with one or more of the Bluetooth and/or IEEE 802.11 family of communication standards. The receiver 144 is coupled to the microprocessor 128, and the receiver 144, in operation, receives signals from the tracking devices 106 and the visualization device 108. For example in one or more embodiments, the receiver 144 operates in accordance with one or more of the Bluetooth and/or IEEE 802.11 family of communication standards. In one or more embodiments, the receiver 144 receives signals from the position indicator 102. In one or more embodiments, the receiver 144 is included in the sensor 140 and receives one or more signals from the tip of the core body 114 of the position indicator 102 by electromagnetic induction.

Having described the structure of the visualization system 100, an example of a method 200 performed by the visualization system 100 will now be described in connection with FIG. 4, which shows a flowchart of the method 200, according to one or more embodiments of the present disclosure. The method 200 begins at 202, for example, upon powering on the processing device 104.

At 202, one or more signals indicative of one or more spatial positions of the position indicator 102 in a 3-dimensional space are received. For example, the receiver 144 of the processing device 104 receives one or more signals from the tracking devices 106. Additionally or alternatively, the microprocessor 128 receives one or more signals from the sensor 140 of the processing device 104. The method 200 then proceeds to 204.

At 204, a signal indicative of the position of the switch 120 of the position indicator 102 is received. For example, the receiver 144 of the processing device 104 receives the signal indicative of the position of the switch 120 from the transmitter 124 of the position indicator 102. The method 200 then proceeds to 206.

Optionally, at 206, a signal indicative of the acceleration of the position indicator 102 is received. For example, the receiver 144 of the processing device 104 receives the signal indicative of the acceleration of the position indicator 102 from the transmitter 124 of the position indicator 102. The method 200 then proceeds to 208.

At 208, a signal indicative of the pressure applied to the tip of the core body 114 is received. For example, the receiver 144 of the processing device 104 receives the signal indicative of the pressure applied to the tip of the core body 114 from the transmitter 124 of the position indicator 102. Additionally or alternatively, the sensor 140 of the processing device 104 receives the signal indicative of the pressure applied to the tip of the core body 114 from the tip of the core body 114 of the position indicator 102 by electromagnetic induction. The method 200 then proceeds to 210.

At 210, one or more signals indicative of one or more physical objects that are located in the vicinity of a user of the visualization system 100 are received. In one or more embodiments, the receiver 144 of the processing device 104 receives the signals indicative of the one or more physical objects that are located in the 3-dimensional space in the vicinity of the user from the sensor 109 of the visualization device 108. For example, the receiver 144 receives image data generated by a pair of cameras of the sensor 109, and the microprocessor 128 processes the image data and obtains coordinates corresponding to exterior surfaces of objects imaged by the cameras. The method 200 then proceeds to 212.

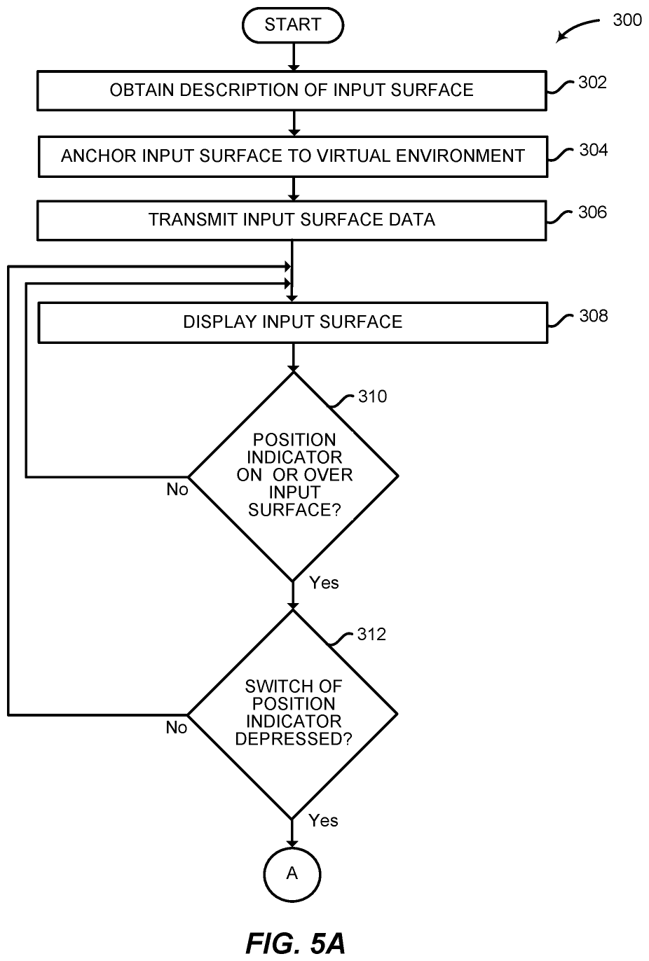

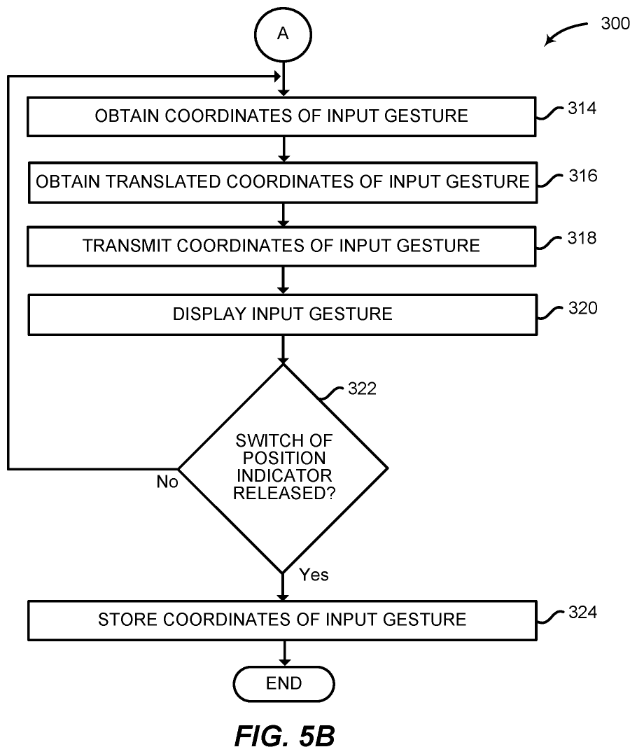

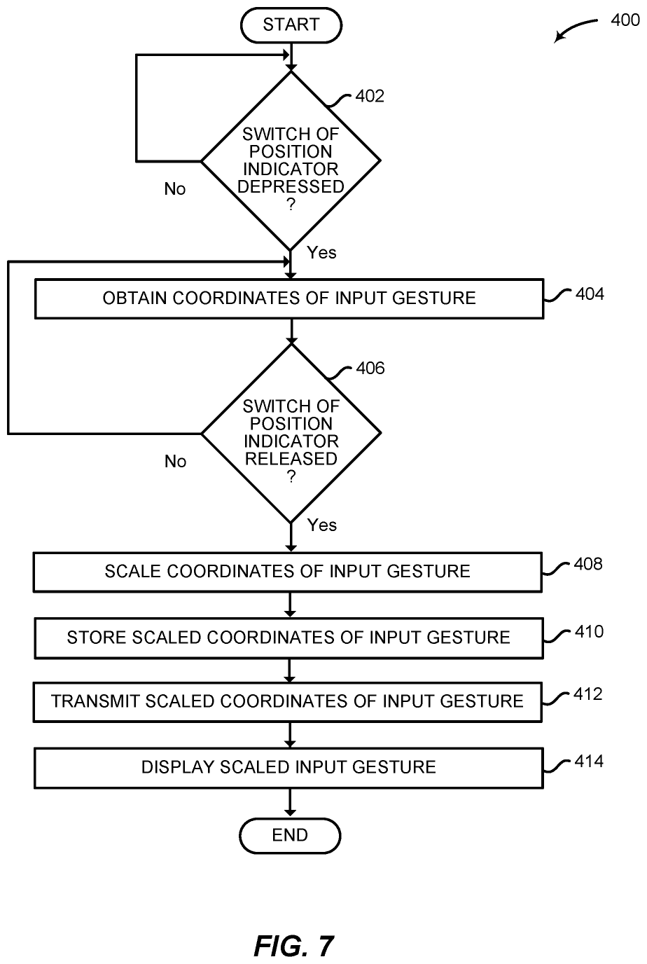

At 212, the signals received at 202, 204, 206, 208, and 210 are processed. In one or more embodiments, data transmitted by those signals are timestamped and stored in the memory 130 of the processing device 104, and the CPU 132 processes the data in chronological order based on timestamps associated with the data. Processing corresponding to the flowcharts shown in FIGS. 5A, 5B, and 7 may be performed at 212, as will be explained below. The method 200 then proceeds to 214.

At 214, a determination is made whether an end processing instruction has been received. For example, the microprocessor 128 determines whether the position indicator 102 has been used to select a predetermined icon or object that is displayed by the display device 138 of the processing device 104. By way of another example, the microprocessor 128 determines whether a voice command corresponding to the end operation has been received at 214. If a determination is made that the end operation has been received at 214, the method 200 ends. If not, the method 200 returns to 202.

FIGS. 5A and 5B show a flowchart of a method 300 that may be performed by the visualization system 100 at 212 of the method 200 described above, according to one or more embodiments of the present disclosure. The method 300 begins at 302 in response to the microprocessor 128 determining that an instruction to define an input surface has been received. For example, the microprocessor 128 determines that the position indicator 102 has been used to select a predetermined icon or object that is displayed by the display device 138 of the processing device 104. By way of another example, the method 300 begins at 302 in response to the microprocessor 128 determining that a voice command corresponding to the instruction to define the input surface has been received.

At 302, a description of an input surface is obtained. In one or more embodiments, the microprocessor 128 uses the one or more signals indicative of one the more spatial positions of the position indicator 102 that are received at 202 of the method 200 described above to determine coordinates of an outline or boundary of a surface that is to be used an input surface. For example, the microprocessor 128 uses the one or more signals indicative of one the more spatial positions of the position indicator 102 to obtain an outline of a region corresponding to the input surface, in a “local” coordinate system that is relative to a reference location (e.g., an origin of the coordinate system) used by the visualization device 108. The method 300 then proceeds to 304.

At 304, the input surface is anchored to a virtual environment as a virtual surface. Once the input surface is anchored to the virtual environment as the virtual surface, the virtual surface remains stationary relative to the virtual environment even if a user wearing the visualization device 108 moves to a different physical location. In one or more embodiments, the visualization system 100 includes a position detecting part similar to the one described in U.S. Pre-Grant Publication No. 2016/0343174 (see, e.g., paragraph [0074]), and the processing device 104 displays the virtual surface by performing the method shown in FIG. 5 and described in paragraphs [0074]-[0099] of U.S. Pre-Grant Publication No. 2016/0343174, which is incorporated by reference herein in its entirety.

In one or more embodiments, the microprocessor 128 uses the one or more signals indicative of the one or more physical objects that are located in the vicinity of the user of the visualization system 100 received at 210 of the method 200 described above to build a model of the physical objects in the virtual environment. For example, the microprocessor 128 translates or otherwise converts the coordinates that describe the input surface obtained at 302 of the method 300 described above from the “local” coordinate system relative to the reference location used by the position of the visualization device 108, to a “global” coordinate system corresponding to the virtual environment that uses a virtual reference location corresponding to a physical location in the vicinity of the user of the visualization system 100, and uses the translated coordinates to partition or bound a physical surface in the vicinity of the user of the visualization system 100. In other words, the microprocessor 128 assigns coordinates of the physical surface that are on and/or within the description (e.g., outline) of the input surface obtained at 302, to a virtual input surface corresponding to the bounded physical surface. The method 300 then proceeds to 306.

At 306, data describing the virtual input surface obtained at 304 is transmitted. In one or more embodiments, the microprocessor 128 of the processing device 104 causes the transmitter 142 to transmit the data describing the virtual input surface to the visualization device 108. In one or more embodiments, the microprocessor 128 transmits the data describing the virtual input surface to the display device 138 of the processing device 104. The method 300 then proceeds to 308.

At 308, the data describing the virtual input surface are rendered and the virtual input surface is displayed. In one or more embodiments, the visualization device 108 performs rendering of two-dimensional images to obtain a three-dimensional (3D) representation of the virtual input surface. In one or more embodiments, the microprocessor 128 causes the display device 138 of the processing device 104 to render the visualization data and display the virtual input surface. The method 300 then proceeds to 310.

At 310, a determination is made whether the position indicator 102 is located on or above the input surface. In one or more embodiments, the microprocessor 128 uses the one or more signals indicative of one the more spatial positions of the position indicator 102 that are received at 202 of the method 200 described above to determine whether the position indicator 102 is located on or above the input surface. If a determination is made that the position indicator 102 is located on or above the input surface, the method 300 proceeds to 312. If not, the method 300 returns to 308.

At 312, a determination is made whether a switch of the position indicator 102 is depressed. For example, the microprocessor 128 determines whether the switch 120 of the position indicator 102 is in the “on” or “closed” position based on the signal indicative of the position of the switch 120 received at 204 of the method 200 described above. If a determination is made that the switch 120 of the position indicator 102 is in the “on” or “closed” position, the method 300 proceeds to 314. If not, the method 300 returns to 308.

At 314, coordinates corresponding to an input gesture are obtained. In one or more embodiments, the microprocessor 128 uses the one or more signals indicative of one the more spatial positions of the position indicator 102 that are received at 202 of the method 200 described above while the position indicator 102 is disposed on or above the input surface to obtain the coordinates corresponding to the input gesture. The method 300 then proceeds to 316.

At 316, the coordinates corresponding to the input gesture are translated in order to obtain translated coordinates corresponding to the input gesture. In one or more embodiments, the microprocessor 128 of the processing device 104 translates or otherwise converts the coordinates that describe the input gesture obtained at 314 from the “global” coordinate system corresponding to the virtual environment, to the “local” coordinate system relative to the reference position used by the visualization device 108. The method 300 then proceeds to 318.

At 318, the coordinates corresponding to the input gesture obtained at 314 or 316 are transmitted. In one or more embodiments, the microprocessor 128 of the processing device 104 causes the transmitter 142 to transmit the coordinates corresponding to the input gesture obtained at 314 or 316 to the visualization device 108. In one or more embodiments, the microprocessor 128 transmits the coordinates corresponding to the input gesture obtained at 314 or 316 to the display device 138 of the processing device 104. The method 300 then proceeds to 320.

At 320, the input gesture is rendered and displayed. In one or more embodiments, the visualization device 108 performs rendering of two-dimensional images to obtain a three-dimensional (3D) representation of the input gesture. In one or more embodiments, the microprocessor 128 causes the display device 138 of the processing device 104 to render and display the input gesture. The method 300 then proceeds to 322.

At 322, a determination is made whether the switch of the position indicator is released. For example, the microprocessor 128 determines whether the switch 120 of the position indicator 102 is in the “off” or “open” position based on the signal indicative of the position of the switch 120 received at 204 of the method 200 described above. If a determination is made that the switch 120 of the position indicator 102 is in the “off” or “open” position, the obtaining of the coordinates corresponding to the input gesture is ended and the method 300 proceeds to 324. If not, the method 300 returns to 314 and additional coordinates corresponding to the input gesture are obtained.

At 324, the coordinates corresponding to the input gesture obtained at 314 or 316 are stored. In one or more embodiments, the microprocessor 128 of the processing device 104 causes the coordinates corresponding to the input gesture obtained at 314 or 316 to be stored in the memory 130 and/or the memory 134. The method 300 then ends.

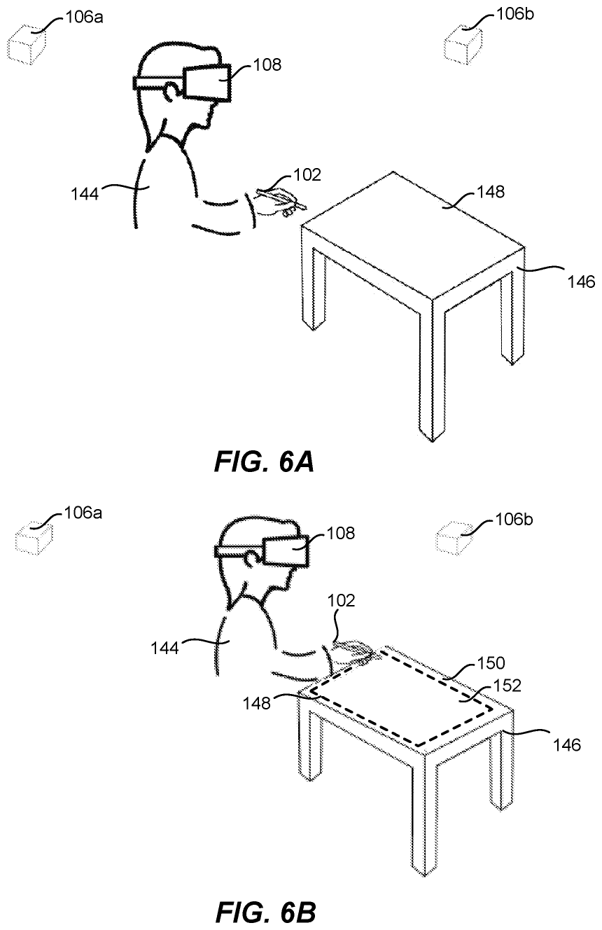

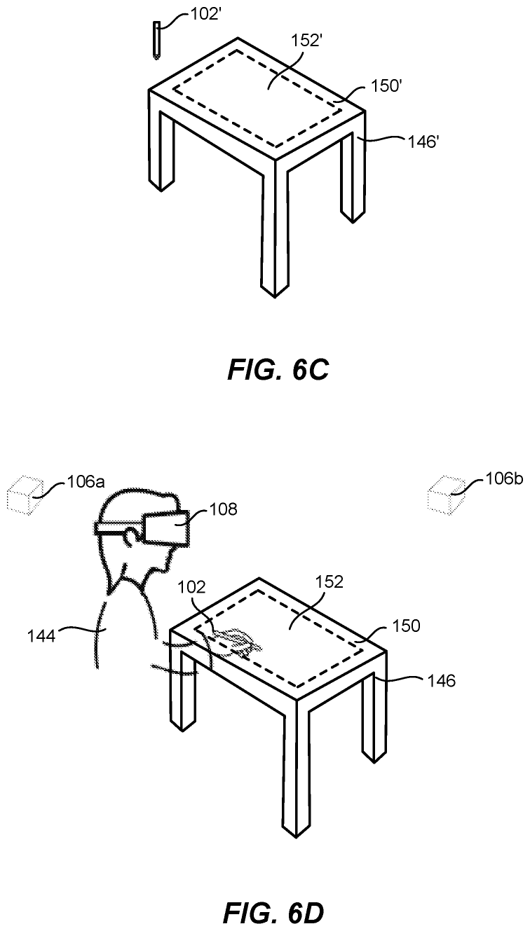

FIGS. 6A, 6B, 6C, and 6D are diagrams for explaining operation of the visualization system 100 during the method 300 described above, according to one or more embodiments of the present disclosure. Assume a user 144 is physically located in an environment that includes a table 146, as shown in FIG. 6A. The tracking devices 106a and 106b also are physically located in the environment in the vicinity of the user 144. In addition, the user 144 is wearing the visualization device 108.

As shown in FIG. 6B, the user 144 uses the position indicator 102 to sketch a pattern 148 on an upper surface 150 of the table 146, in order to specify a portion 152 of the upper surface 150 of the table 146 as an input surface. The processing device 104 receives coordinates of the position indicator 102 while the position indicator 102 is used to sketch the pattern 148 at 302 of the method 300 described above. The user 144 then indicates to the processing device 104 that the portion 152 of the upper surface 150 of the table 146 is to be used an input surface, for example, by performing a “double click” operation using the switch 120 of the position indicator 102 or by issuing a corresponding voice command.

In response, the processing device 104 anchors the portion 152 of the upper surface 150 of the table 146 as an input surface at 304 of the method 300 described above. The processing device 104 then transmits corresponding position data for the portion 152 of the upper surface 150 of the table 146 to the visualization device 108 at 306 of the method 300 described above. The visualization device 108 displays virtual representations of the portion 152 of the upper surface 150 of the table 146 at 308 of the method 300 described above. The portion 152 of the upper surface 150 of the table 146 will be referred to as input surface 152 hereinafter. FIG. 6C shows an example of a virtual representation 102′ of the position indicator 102, a virtual representation 146′ of the table 146, and a virtual representation 152′ of the input surface 152 anchored to a virtual representation 150′ of the upper surface 150 of the table 146, which is displayed by the visualization device 108.

In one or more embodiments, the visualization device 108 displays the virtual representation 152′ of the input surface 152 in a visually distinct manner. For example, the visualization device 108 displays the virtual representation 152′ of the input surface 152 in a distinct color or with a distinct brightness so that the user 144 can easily identify the virtual representation 152′ of the input surface 152 while the user 144 is viewing the output of the visualization device 108.

As shown in FIG. 6D, the user 144 is then able to move the position indicator 102 on or over the input surface 152 and use the input surface 152 in a manner similar to using the position indicator 102 on or over the input surface 116 of the sensor 140 of the processing device 104. For example, while using the position indicator 102 on or over the input surface 152, the user 144 may depress the switch 120 of the position indicator 102 to indicate to the processing device 104 that it should store coordinates of subsequent locations of the position indicator 102 as an input gesture. The processing device 104 determines that the position indicator 102 is located on or over the input surface 152 and that the user 144 has depressed the switch 120 of the position indicator 102 at 310 and 312, respectively, of the method 300 described above.

Subsequently, the processing device 104 obtains coordinates corresponding to the input gesture at 314 of the method 300 described above, which are in the “global” coordinate system corresponding to the virtual environment. The processing device 104 also translates or otherwise converts the coordinates into corresponding coordinates in the “local” coordinate system of the visualization device 108 at 316 of the method 300 described above. The processing device 104 transmits the coordinates to visualization device 108 at 318 of the method 300 described above. The visualization device 108 displays the input gesture, for example, as line segments that interconnect the coordinates corresponding to the input gesture. The user 144 may then release the switch 120 of the position indicator 102 to indicate to the processing device 104 that it should stop storing coordinates of locations of the position indicator 102 as the input gesture. The processing device 104 determines that the user 144 has released the switch 120 of the position indicator 102 at 322 of the method 300 described above. The processing device 104 then stores the coordinates corresponding to the input gesture at 324 of the method 300 described above.

FIG. 7 shows a flowchart of a method 400 that may be performed by the visualization system 100 at 212 of the method 200 described above, according to one or more embodiments of the present disclosure. The method 400 begins at 402, for example, in response to the microprocessor 128 determining that an instruction to perform exaggerated input processing has been received. For example, the microprocessor 128 determines that the position indicator 102 has been used to select a predetermined icon or object that is displayed by the display device 138 of the processing device 104. By way of another example, the method 400 begins at 402 in response to the microprocessor 128 determining that a voice command corresponding to the instruction to perform exaggerated input processing has been received. By way of yet other examples, the microprocessor 128 may evaluate accelerometer data of the position indicator 102 or evaluate coordinate data corresponding to an input gesture made by the position indicator 102 and determine from the evaluated data that an instruction to perform exaggerated input processing has been received.

At 402, a determination is made whether the switch 120 of the position indicator 102 is depressed. For example, the microprocessor 128 determines whether the switch 120 of the position indicator 102 is in the “on” or “closed” position based on the signal indicative of the position of the switch 120 received at 204. If a determination is made that the switch 120 of the position indicator 102 is in the “on” or “closed” position, the method 400 proceeds to 404. If not, the method 400 returns to 402.

At 404, coordinates corresponding to an input gesture performed using the position indicator 102 are obtained. In one or more embodiments, the microprocessor 128 of the processing device 104 obtains the coordinates corresponding to the input gesture based on the signal indicative of the position of the position indicator 102 received at 202 of the method 200 described above. The method 400 then proceeds to 406.

At 406, a determination is made whether the switch 120 of the position indicator 102 is released. For example, the microprocessor 128 determines whether the switch 120 of the position indicator 102 is in the “off” or “open” position based on the signal indicative of the position of the switch 120 received at 204 of the method 200. If a determination is made that the switch 120 of the position indicator 102 is in the “off” or “open” position, the method 400 proceeds to 408. If not, the method 400 returns to 404.

At 408, the coordinates corresponding to the input gesture obtained at 404 are scaled. In one or more embodiments, the microprocessor 128 of the processing device 104 scales the coordinates corresponding to the input gesture using a predetermined scaling factor. For example, the microprocessor 128 may obtain one or more signals indicative of the scaling factor in response to the position indicator 102 being used to select a predetermined icon or object displayed by the display device 138 of the processing device 104. The method 400 then proceeds to 410.

If the scaling factor is set to “10”, for example, the microprocessor 128 scales the coordinates such that the actual input gesture is scaled up by a factor of ten. In other words, if the input gesture corresponds to a user moving the position indicator 102 from an initial location in an arc having a length of one meter, the microprocessor 128 scales the coordinates such that the scaled coordinates define an arc that extends a length of ten meters from a corresponding initial location in the same relative shape as the actual input gesture.

Similarly, if the scaling factor is set to “−10” or “1/10”, for example, the microprocessor 128 scales the coordinates such that the actual input gesture is scaled down by a factor of ten. In other words, if the input gesture corresponds to a user moving the position indicator 102 from an initial location in an arc having a length of one meter, the microprocessor 128 scales the coordinates such that the scaled coordinates define an arc that extends a length of one-tenth of a meter from a corresponding initial location in the same relative shape as the actual input gesture. Accordingly, the scaling factor can be set to enable a user to more precisely sketch relatively small objects.

In one or more embodiments, the microprocessor 128 of the processing device 104 scales the coordinates corresponding to the input gesture using a scaling factor that is dynamically obtained based on the amount of pressure applied to the tip of the core body 114, which may extend from an opening formed in a side surface of the case 110 of the position indicator 102. For example, the microprocessor 128 dynamically obtains the scaling factor based on the signal indicative of the pressure applied to the tip of the core body 114 that is received at 208 of the method 200 described above. Accordingly, a user can indicate the scaling factor to the processing device 104 by applying pressure to the tip of the core body 114. In one or more embodiments, the processing device 104 causes the visualization device 108 and/or display device 138 to display the scaling factor. Accordingly, a user viewing the displayed scaling factor can determine whether to increase, decrease, or maintain the pressure applied to the tip of the core body 114 in order to set a desired scaling factor.

In one or more embodiments, the scaling factor is directly proportional to the pressure applied to the tip of the core body 114. For example, the scaling factor increases with increasing pressure that the user applies to the tip of the core body 114. By way of another example, the scaling factor decreases with increasing pressure that the user applies to the tip of the core body 114.

In one or more embodiments, if the user changes the amount of pressure applied to the tip of the core body 114 by more than a predetermined threshold amount during different segments of an input gesture, the microprocessor 128 dynamically adjusts the scaling factor. Accordingly, the microprocessor 128 may use different scaling factors on different segments of the input gesture.

In one or more embodiments, the microprocessor 128 of the processing device 104 scales the coordinates corresponding to the input gesture using a scaling factor that is dynamically obtained based on the acceleration of the position indicator 102. The microprocessor 128 may dynamically obtain the scaling factor based on the signal indicative of the acceleration of the position indicator 102 that is received at 206 of the method 200 described above. For example, a user can indicate the scaling factor to the processing device 104 by accelerating the position indicator 102, wherein the greater the acceleration of the position indicator 102, the greater the scaling factor used by the processing device 104.

At 410, the coordinates corresponding to the input gesture scaled at 408 are stored. In one or more embodiments, the microprocessor 128 of the processing device 104 causes the coordinates corresponding to the input gesture scaled at 408 to be stored in the memory 130 and/or the memory 134. The method 400 then proceeds to 412.

At 412, the coordinates corresponding to the input gesture stored at 410 are transmitted. In one or more embodiments, the microprocessor 128 of the processing device 104 causes the transmitter 142 to transmit the coordinates corresponding to the input gesture scaled at 408 to the visualization device 108. In one or more embodiments, the microprocessor 128 transmits the coordinates corresponding to the input gesture scaled at 408 to the display device 138 of the processing device 104. The method 400 then proceeds to 414.

At 414, a virtual representation of the input gesture is displayed. In one or more embodiments, the visualization device 108 performs rendering of two-dimensional images to obtain a three-dimensional (3D) representation of the input gesture. In one or more embodiments, the microprocessor 128 causes the display device 138 of the processing device 104 to display the virtual representation of the input gesture. The method 400 then ends.

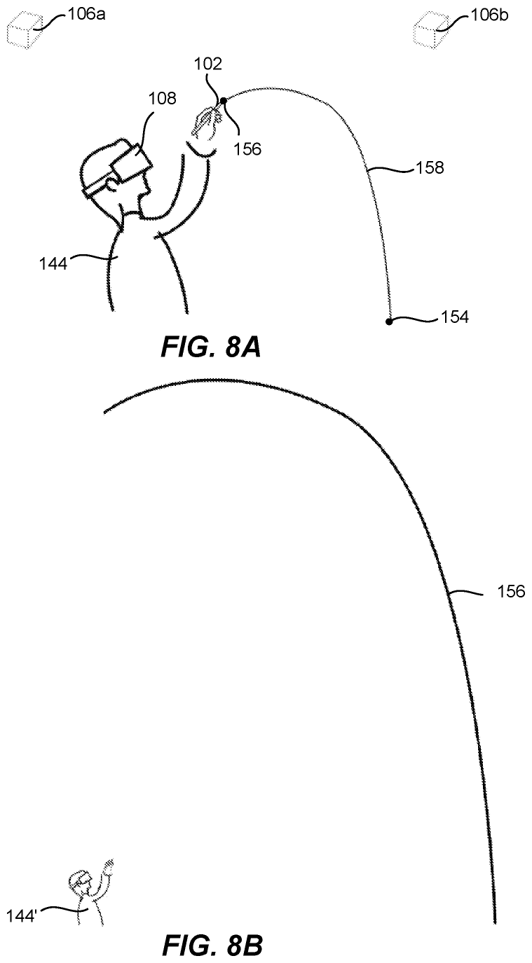

FIGS. 8A and 8B are diagrams for explaining operation of the visualization system 100 during the method 400 described above, according to one or more embodiments of the present disclosure. While depressing the switch 120 of the position indicator 102, a user 144 moves the position indicator 102 from an initial position 154 to a final position 156 in an arc corresponding to an input gesture 158, as shown in FIG. 8A, and then releases the switch 120 of the position indicator 102. The processing device 104 determines that the switch 120 of the position indicator 102 is depressed at 402 of the method 400 described above. In response, the processing device 104 obtains coordinates corresponding to the input gesture 158 at 404 of the method 400 described above, until the processing device 104 determines that the switch 120 of the position indicator 102 is released at 406 of the method 400 described above. The processing device 104 then scales the coordinates corresponding to the input gesture 158 at 408 of the method 400 described above. The processing device 104 then stores the scaled coordinates corresponding to the input gesture 158 at 410 of the method 400 described above. The processing device 104 also transmits the scaled coordinates corresponding to the input gesture 158 at 412 of the method 400 described above.

The visualization device 108 displays a virtual representation of a scaled input gesture 160 at 414 of the method 400 described above. FIG. 8B shows a virtual environment that is displayed by the visualization device 108. The virtual environment includes a to-scale, virtual representation 144′ of the user 144 and the virtual representation of the scaled input gesture 160. As can be seen by comparing FIG. 8A and 8B, the scaled input gesture 160 is many times larger than the actual input gesture 158. At 414 of the method 400 described above, the visualization device 108 may display a message 162 that indicates the scaling factor being used to create the scaled input gesture 160. In addition, at 414 of the method 400 described above, the visualization device 108 may display a legend 164 that is based on the scaling factor to visually indicate to the user 144 a scaled dimension of the scaled input gesture 160. Accordingly, when the method 400 is performed, a user 144 is able to sketch relatively large objects with ease through simple operation of the position indicator 102.

The various embodiments described above can be combined to provide further embodiments. Aspects of the embodiments can be modified, if necessary to employ concepts of the various patents referred to in this specification to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method comprising:
receiving one or more signals indicative of a plurality of spatial positions of a position indicator in a 3-dimensional space;
receiving one or more signals indicative of a surface of a physical object in the 3-dimensional space;
obtaining a description of a portion of the surface of the physical object based on the one or more signals indicative of the plurality of spatial positions of the position indicator and the one or more signals indicative of the surface of the physical object;
determining whether the position indicator is on or over the portion of the surface of the physical object based on the one or more signals indicative of the plurality of spatial positions of the position indicator;
responsive to determining that the position indicator is on or over the portion of the surface of the physical object, obtaining coordinates corresponding to an input gesture based on the one or more signals indicative of the plurality of spatial positions of the position indicator; and
storing the coordinates corresponding to the input gesture.

2. The method of claim 1, further comprising:
displaying a virtual representation of the position indicator along with a virtual representation of the portion of the surface of the physical object.

3. The method of claim 1, further comprising:
receiving one or more signals indicative of a plurality of positions of a switch of the position indicator; and
determining whether the switch of the position indicator is in a first positon, based on the one or more signals indicative of the plurality of positions of the switch of the position indicator,
wherein the obtaining of the coordinates corresponding to the input gesture is responsive to determining that the position indicator is on or over the portion of the surface of the physical object and responsive to determining that the switch of the position indicator is in the first positon.

4. The method of claim 1, further comprising:
translating coordinates corresponding to the portion of the surface of the physical object from a first coordinate system to a second coordinate system, the first coordinate system being different from the second coordinate system.

5. The method of claim 1 wherein:
the position indicator includes a plurality of reference tags, and
the one or more signals indicative of the plurality of spatial positions of the position indicator are indicative of a plurality of positions of the reference tags.

6. The method of claim 5 wherein:
each of the reference tags includes a visually distinct pattern formed thereon, and
the one or more signals indicative of the plurality of spatial positions of the position indicator include image data corresponding to a plurality of images of the references tags.

7. The method of claim 5 wherein:
each of the reference tags emits light, and
the one or more signals indicative of the plurality of spatial positions of the position indicator include image data corresponding to a plurality of images of the references tags.

8. A method comprising:
receiving one or more signals indicative of a plurality of spatial positions of a position indicator in a 3-dimensional space;
obtaining one or more signals indicative of a scaling factor;
obtaining coordinates corresponding to an input gesture in the 3-dimensional space based on the one or more signals indicative of the plurality of spatial positions of the position indicator;
scaling the coordinates corresponding to the input gesture based on the one or more signals indicative of the scaling factor; and
displaying a virtual representation of the input gesture based on the scaling of the coordinates corresponding to the input gesture.

9. The method of claim 8, further comprising:
displaying the scaling factor.

10. The method of claim 8, further comprising:
receiving a signal indicative of a pressure applied to a part of the position indicator, wherein the scaling factor is based on the signal indicative of the pressure applied to the part of the position indicator.

11. The method of claim 8, further comprising:
receiving a signal indicative of an acceleration of the position indicator, wherein the scaling factor is based on the signal indicative of the acceleration of the position indicator.

12. The method of claim 8, further comprising:
receiving one or more signals indicative of a plurality of positions of a switch of the position indicator; and
determining whether the switch of the position indicator is in a first positon, based on the one or more signals indicative of the plurality of positions of the switch of the position indicator,
wherein the obtaining of the coordinates corresponding to the input gesture is responsive to determining that the switch of the position indicator is in the first positon.

13. The method of claim 12, further comprising:
determining whether the switch of the position indicator is in a second positon, based on the one or more signals indicative of the plurality of positions of the switch of the position indicator,
wherein the obtaining of the coordinates corresponding to the input gesture is ended responsive to determining that the switch of the position indicator is in the second positon.

14. The method of claim 8 wherein:
the position indicator includes a plurality of reference tags, and
the one or more signals indicative of the plurality of spatial positions of the position indicator are indicative of a plurality of positions of the reference tags.

15. The method of claim 14 wherein:
each of the reference tags includes a visually distinct pattern formed thereon,
the one or more signals indicative of the plurality of spatial positions of the position indicator include image data corresponding to a plurality of images of the references tags.

16. The method of claim 14 wherein:
each of the reference tags emits light,
the one or more signals indicative of the plurality of spatial positions of the position indicator include image data corresponding to a plurality of images of the references tags.

17. A system comprising:
one or more receivers which, in operation, receive one or more signals indicative of a plurality of spatial positions of a position indicator in a 3-dimensional space, and one or more signals indicative of a surface of a physical object in the 3-dimensional space;
one or more processors coupled to the one or more receivers; and
one or more memory devices coupled to the one or more processors, the one or more memory devices storing instructions that, when executed by the one or more processors, cause the system to:
obtain a description of a portion of the surface of the physical object based on the one or more signals indicative of the plurality of spatial positions of the position indicator and the one or more signals indicative of the surface of the physical object;
determine whether the position indicator is on or over the portion of the surface of the physical object based on the one or more signals indicative of the plurality of spatial positions of the position indicator;
responsive to determining that the position indicator is on or over the portion of the surface of the physical object, obtain coordinates corresponding to an input gesture based on the one or more signals indicative of the plurality of spatial positions of the position indicator; and
store the coordinates corresponding to the input gesture.

18. The system of claim 17 wherein the one or more memory devices store instructions that, when executed by the one or more processors, cause the system to display a virtual representation of the position indicator along with a virtual representation of the portion of the surface of the physical object.

19. The system of claim 17 wherein the one or more memory devices store instructions that, when executed by the one or more processors, cause the system to:
obtain an indication of a scaling factor; and
obtain coordinates corresponding to a scaled input gesture based on the scaling factor and the coordinates corresponding to the input gesture.

20. The system of claim 19 wherein the one or more memory devices store instructions that, when executed by the one or more processors, cause system to display a virtual representation of the scaled input gesture.
